(19) United States
(12) Patent Application Publication
(10) Pub. No.: US 2020/0374605 A1
(43) Pub. Date: Nov. 26, 2020

(54) Systems and Methods for Identifying Greenhouse Gas Emission Reductions and Carbon Emission Reduction Credits

(71) Applicant: GRID20/20, Inc., Richmond, VA (US)

(72) Inventors: W. Alan Snook, II, York, PA (US); Jagtar S. Dhaliwal, Coquitlam (CA)

(73) Assignee: GRID20/20, Inc., Richmond, VA (US)

(21) Appl. No.: 16/883,984

(22) Filed: May 26, 2020

Related U.S. Application Data
(60) Provisional application No. 62/851,797, filed on May 23, 2019.

(51) Int. Cl. H04Q 9/00; G06Q 50/06

(52) U.S. Cl. CPC H04Q 9/00; H04Q 2209/60; G06Q 50/06

(57) ABSTRACT

The present disclosure is a system for reducing greenhouse gas emissions that has an intra-grid sensor coupled to a secondary side of a transformer, and the transformer delivers power to a customer premise through a meter. Further, the intra-grid sensor measures an amount of power at the transformer to be delivered to the customer premise through the meter and transmits data indicative of the measured power at the transformer to a server. Also, the system has a processor resident on the server that ascertains non-technical loss based upon the data indicative of the measured power.

### CROSS REFERENCE TO RELATED APPLICATION

This application claims priority to U.S. Provisional Patent Application Ser. No. 62/851,797 and entitled Systems and Methods for Identifying Greenhouse Gas Emissions Reductions and Carbon Emission Reduction Credits filed on May 23, 2019, which is incorporated herein by reference.

### BACKGROUND

Today, most utilities experience energy Loss within their distribution grid. The term “Loss” implies energy that is injected into the grid but is not ultimately delivered to the intended endpoint metering locations within the grid architecture. Such Loss is typically categorized as both Technical Loss, and Non-Technical Loss; or commonly aggregated within the electric utility industry and referred to simply as “Line Loss”.

Technical Loss is typically associated with the inherent physics of delivering electrons through a series of transmission and distribution assets which collectively cause some electrons to dissipate from the grid primarily resulting from heat dissipation and resistance. Further, most utilities also experience energy inefficiency/waste due to several factors that occur within the distribution grids, typically occurring within the grid segment between substations and endpoint metering, but more specifically occurring from the distribution transformers downstream to the endpoint metering systems. This type of energy inefficiency/waste is commonly referred to as Non-Technical Loss. Non-Technical Loss is caused by a series of issues including but not limited to power theft, inaccurate metering, unauthorized unmetered consumption, excessive or over-energizing of the distribution grid, and clerical/billing errors. Currently, most power distribution utilities do not possess adequate systems that disclose these Non-Technical Loss instances which can better be described as avoidable unnecessary energy inefficiency/waste that causes undesirable intra-grid conditions, negatively impacts distribution assets, oftentimes is the root cause of power outages, and financially burdens rate paying customers.

In this regard, to ensure that utilities sufficiently serve the electricity needs of their customers, utilities commonly send enough energy into their distribution grids to collectively a) ensure that the actual metered demand by ratepayers is serviced; b) the inherent Technical Loss is serviced; and c) the Non-Technical (i.e., energy inefficiency/waste) Loss is also serviced. In essence, this collective level of energy provided into the distribution grids must account for the customer demand, plus the inherent Technical energy Loss, plus the additional energy inefficiency/waste Non-Technical Loss to ensure that the distribution grid is adequately servicing all customers within industry-stated legal limits. While this Technical and Non-Technical (i.e., energy inefficiency/waste) Loss is commonly referred to in aggregate as “Line Loss”, sometimes giving the impression that all Loss is of the inherently Technical variety, the likelihood is that only a modest percentage of all “Line Loss” is actually due to Technical Loss. Thereby presenting an opportunity to identify and remediate unnecessary and avoidable Non-Technical Loss. Because utilities heretofore have not had access to cost-effective technology required to provide grid operators with a clear understanding of the distinction between Technical Loss and Non-Technical Loss within their distribution grid(s), all such Loss is collectively termed “Line Loss” and is collectively written off as non-billable revenue loss by the respective utility. In turn, utilities are then typically permitted to subsequently amortize all of this aggregated “Line Loss” across their rate payer bills to compensate the utility for the “Line Loss” as if the unmetered aggregated “Line Loss” energy amount actually had been delivered to the rate paying customers. Thus, rate paying customers are financially burdened to pay for both Technical Loss and identifiable/remediable Non-Technical Loss via their electricity bills, above and beyond the energy the rate payers verifiably consume via endpoint metering at their residence, commercial, industrial, and/or institutional property site.

### SUMMARY OF THE DRAWINGS

The disclosure can be better understood referencing the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a diagram depicting an exemplary power transmission and distribution system in accordance with an embodiment of the present disclosure.

FIG. 2 is a diagram of an exemplary system for identifying GHG emission reductions and carbon emission credits.

FIG. 3 is a drawing of a general-purpose transformer monitoring device, such as is depicted by FIG. 1.

FIG. 4 is a block diagram of the exemplary general-purpose transformer monitoring device, such as is depicted in FIG. 3.

FIG. 5 depicts a polyphase intra-grid sensor device, such as is depicted by FIG. 1.

FIG. 6 is a block diagram of the exemplary polyphase intra-grid sensor device, such as is depicted in FIG. 5.

FIG. 7 is a block diagram of an exemplary server, such as is depicted in FIG. 2.

### DETAILED DESCRIPTION

The present disclosure describes a system that comprises a plurality of intra-grid sensors. The system comprising the intra-grid sensors gives operators and/or utility companies the ability to identify the distinction between unavoidable inherent Technical Loss, and the identifiable, remediable Non-Technical (i.e., energy inefficiency/waste) Loss that commonly occurs throughout distribution grids. They system identifies and enables an operator to remediate unnecessary and avoidable Non-Technical Loss.

In this regard, the technical loss is the actual loss of energy resulting from resistance and heat dissipation across power lines and within distribution transformers. The present system enables the utilities to identify non-technical loss (i.e., energy inefficiency/waste) effectively and accurately. In contrast, historically advanced metering infrastructure (i.e., AMI), the industry practice has been to simply consider all loss to be categorized as line loss, and therefore be eligible for cost recovery via amortization across the rate payer base.

With the present system, intra-grid sensors aid in quantifying the three areas of potential technical loss occurring between substations to endpoint meters. The quantifying clarifies that technical loss is unlikely to be the cause of all “line loss”.

For example, a) because most substation-to-distribution transformer power line spans within the distribution grids are not involving substantial distances, and are transmitting power at high voltages (e.g., most typically distributing within the range of 4 kV to 35 kV which is 4,000 to 35,000 volts) only a modest amount of actual technical loss occurs between the substations down to the distribution transformers, b) the technical loss associated within the actual transformer assets is typically negligible as transformers by design are relatively efficient conductors of energy, and c) the technical loss between transformers to endpoint meters is also minimal due to the typically short power line spans and the stepped-down or reduced energy levels that are being delivered from transformers to residential and commercial customer meters. Thus, the technical line loss is minimal compared to non-technical loss, which is described further herein.

Non-technical loss accounts for most loss in the electrical grid. In this regard, the intra-grid sensors of the present disclosure empirically determine and identify the difference between technical loss and non-technical loss by isolating remediable energy inefficiency/waste instances occurring within the distribution grid. Note that it is highly likely that up to or over 50% of all commonly aggregated line loss is comprised of identifiable and therefore remediable non-technical loss. In one embodiment, the non-technical loss is comprised of energy inefficiency and unnecessary energy waste that the intra-grid sensors can identify. Thus, the non-technical loss (i.e., energy inefficiency/waste) can therefore be effectively identified and remediated using the present system, and the related unnecessary costs and unnecessary grid-related impacts caused by non-technical loss is proactively resolved by grid operators by use of the intra-grid sensors.

This remediation of non-technical loss (i.e., energy inefficiency/waste) leads to improved energy efficiency by extinguishing multiple root causes of energy inefficiency, and ultimately enables the successful decrease in greenhouse gas (GHG) emissions at the generation level. That is, at the level of the power station 10. Notably, electricity generation by the power station 10 is driven across transmission lines, then delivered into/through the distribution grids, and ultimately to endpoint meters for customer consumption. Thus, as non-technical Loss (i.e., energy inefficiency/waste) is removed from the distribution grid using the present system, less generation of energy is required since the energy inefficiency/waste is lessened by the remediation of identifiable non-technical loss. In turn, energy efficiency replaces energy inefficiency/waste thereby resulting in a lesser energy generation demand on the power station 10, whereas the perennial energy inefficiency/waste conditions have required generation to collectively serve actual customer demand, plus technical loss, plus non-technical Loss.

Types of non-technical loss consist of loss attributed to power theft, over-sized and therefore inefficiently operating transformers, improper phase balancing, excessive voltage levels associated within over-energized distribution grids or sections of distribution grids, improper transformer tap settings, and clerical/billing errors.

To enable remediation of these non-technical loss, the intra grid sensors, for example, may compare power output by the transformer to which it is coupled to power at an endpoint, e.g., a meter. If there is a discrepancy between the power output and the power usage at the meter, the system notifies an operator of this status. Upon receipt of the notification, the operator or utility company can take steps to remedy the problem. Note that the typical energy loss between the intra-grid sensor and the endpoint (or meter) is 1.5% to 2.0%.

In another embodiment, the server, for example, may have stored in its memory a power threshold, e.g., 100 kilo watt per hour (kWh) representing the amount of power that should be provided by the transformer. That is, the transformer to which the intra grid sensor is coupled. If the intra grid sensor detects a large usage above and beyond the 100 kWh, for example the transformer is providing 150 kWh, the server notifies an operator or a utility company that there is excessive usage on the transformer. In response, the operator or utility company can take remedial action.

In another embodiment, the server may store in memory a threshold indicative of the transformers power capability, e.g., 100 kWh. In operation, the intra-grid sensor may detect that the only 20 kWh are being used at the endpoints (or meters). The instar-grid sensor compares the power capability to the power usage, and if the capability is much greater than actual usage at the endpoints may notify the operators or the utility company, and the operators and the utility company can take remedial action to reconcile the capability of the transformer with the actual power usage.

In one embodiment, the system of the present disclosure may aggregate power usage to each endpoint (or meter). In this scenario, the amount of power output by the transformer may be compared to the aggregate of the endpoints. If there is an oversupply of power at the endpoint(s), the system transmits data to the operator or a utility company. The operator or utility may then take remedial action to rectify the oversupply of power.

In one embodiment, the system of the present disclosure may determine that a transformer is grossly over-sized. In this regard, the intra-grid sensor collects data indicative of power output to endpoints (or meters). The intra-grid sensor compares the power output to the power at the endpoints. If the power output provided is extremely less than the power rating on the transformer and the power provided to the transformer, then the system notifies the operator or utility so that the operator or the utility company can take remedial action, e.g., replacing the transformer or adding endpoints that are served by the transformer.

In one embodiment, the system of the present disclosure may identify loss in a grid just based upon reading from the transformers. For example, a typical transformer outputs approximately 100 kWh. If the intra-grid sensor determines that the transformer(s) in an area is outputting 240-250 kWh, the system notifies the operator or the utility of the overage, and the operator and utility can take remedial action.

Presently, ratepayers continue to be overburdened with the unnecessary added costs (e.g., inflated energy costs, inflated utility operations costs, inflated utility asset replacement costs), and outage burdens associated with non-technical loss. In addition, this ongoing energy inefficiency/waste has contributed to the negative environmental impact of unnecessary GHG emissions to support the presently ongoing energy inefficiency/waste associated with non-technical loss. This unnecessary energy inefficiency/waste that is being driven into distribution grids represents an opportunity to create reduced GHG emissions through the implementation of energy efficiency gains that can now be achieved via the use of the intra-grid sensors. The gains are achieved through remediation of differing non-technical loss and can include, but are not limited to power theft, over-sized and therefore inefficiently operating transformers, improper phase balancing, excessive voltage levels associated within over-energized distribution grids or sections of distribution grids, improper transformer tap settings, and clerical/billing errors. The contributors to the perennial wasteful and unnecessary financially burdensome non-technical loss category may consist of power theft, over-sized and therefore inefficiently operating transformers, improper phase balancing, excessive voltage levels associated within over-energized distribution grids or sections of distribution grids, improper transformer tap settings, and clerical/billing errors. Intra-grid sensors help to identify these contributors to non-technical loss, thereby permitting a reduction in GHG by achieving energy efficiency within the distribution grid.

In this regard, losses in an electrical grid equate to kWh. Thus, when remedial action is taken to address the problems described, less GHG are produced, which can result in carbon emission credits (CER). The present system identifies the scenarios that produce elevated GHG. Upon remediation the CERs may be provided. The calculation of GHG and CER is described further herein.

As the intra-grid sensors are used to understand the distinction between technical loss and non-technical loss occurring within distribution grids, it is likely that up to or more than 50% of all presently aggregated line loss is actually non-technical loss (i.e., energy inefficiency/waste) which is identified within distribution grids using the intra-grid sensors and remediated by utility operators. As described above, non-technical line loss may be remediated by the identification by the intra-grid sensors and communication with an operator or a utility company. This remediation means that less energy is being lost in the grid, so energy is being saved. The intra-grid sensors present a new technology resource that can identify non-technical loss within distribution grids, thereby creating distribution energy efficiency maximization and resulting in decreased generation need which will result in a reduction of GHG emissions.

As indicated above, the intra-grid sensors can identify non-technical loss (i.e., energy inefficiency/waste) leading to greenhouse gas emissions reduction. As noted above the advanced metering infrastructure (i.e., AMI) is typically unable to provide reliable, accurate, timely, granular intra-grid information regarding the dynamic intra-grid conditions. This is generally due to: a) pre-meter taps associated with Power Theft which is a well-documented substantial occurrence within virtually all North American distribution grids (and abroad), and b) inaccurate Geographic Information System (GIS) or Customer Information System (CIS) mapping of transformer-to-meter association due to perpetually changing dynamics within the distribution grid. In this regard, AMI meters are typically not connected to the respective transformer that electric distribution utilities' GIS or CIS mappings might errantly suggest, thus causing the AMI intra-grid related data to be unreliable with respect to upstream intra-grid assets and conditions. Even in cases where GIS and CIS mapping might be accurate to some varying percentage, the utility operator typically does not know which instances are properly versus improperly mapped, thereby causing AMI intra-grid data confidence to be further lessened regarding upstream intra-grid conditions. Likewise, pre-meter tapping typically associated with power theft also presents additional unplanned loading impacts on affected transformers for which AMI is unable to detect and quantify this non-technical loss, and therefore unable to report accurately to grid operators. While AMI is unable to deliver reliably accurate intra-grid data, the intra-grid sensors of the present disclosure addresses this need.

Intra-grid sensors of the present disclosure attach to distribution transformers (or less commonly on individual power service lines) and present a reliable upstream reconciliation point for validating grid operators' GIS and CIS mapping, thereby enabling operators to improve their data confidence reported by AMI resulting from the intra-grid sensor's unique, timely, accurate, granular data reporting from the upstream transformer position. The intra-grid sensor reconciliation point value created by intra-grid sensors is unparalleled as it presents required, reliable, timely, accurate, granular data reference points within the distribution grid.

The intra-grid sensors serve the purpose of: a) empirically proving that substantial energy inefficiency (i.e., non-technical loss) exists within electric distribution grids, b) proving that such wasteful loss can be identified then remediated by the utilities, and c) proving that eliminating such non-technical loss (i.e., energy inefficiency/waste), creates energy efficiency which then results in decreased generation, thereby driving GHG emissions reduction through energy efficiency gains being achieved within the distribution grid.

Additionally, the intra-grid sensors can accurately identify/capture/report intra-grid voltages occurring throughout the distribution grid. Commonly, utilities may over-energize their distribution grids to ensure that all customers including those at the end of the respective circuit feeder(s) are provided an ample supply of energy. However, because utilities commonly do not monitor their intra-grid voltages throughout the distribution grid itself, they do not have sufficient awareness of excessively over-energized areas within their grids. This practice results in excessively energized distribution grids (or portions thereof) which equates to wasteful energy inefficiency.

However, once the intra-grid sensors are used to reveal where excessive energy levels are occurring within distribution grids, volt/var optimization (i.e., VVO) practices such as but not limited to conservation voltage reduction (CVR) can be implemented to sufficiently regulate voltage levels throughout segments of, and/or the entire distribution grid. Thus, via intra-grid sensors reveal excessive intra-grid voltages, and utilities subsequently applying remediation practices to lessen the excessive energy levels, energy inefficiency/waste is replaced by energy efficiency. Thus, lesser energy levels are then required within the distribution grid, and this transcends upstream to result in a decrease in generation demand. In turn, lesser generation results in reduced GHG.

Additionally, the intra-grid sensors simultaneously support the benefits of permitting utility operators to embrace distributed energy resources (DER) safely and effectively, and electric vehicle (EV) charging stations occurring at the grid-edge, both of which are emerging solutions to further reduce GHG. While DER and EV are clearly beneficial, both present serious grid-edge management issue for electric distribution utilities if these grid-edge advancements are not sufficiently monitored/managed. For example, each residential EV charging station will add the equivalent of 1 up to 2.5 additional home(s) of added/unplanned loading onto the associated upstream distribution transformer. While the EV is helping to reduce GHG emissions, this unplanned EV charging station load sets the stage for subsequent transformer overloading and imminent power outages, thus impacting utility ratepayers and commercial/industrial (i.e., economic) production along with additional societal impacts. Likewise, DER also offers GHG reduction upsides by utilizing renewable energy to offset traditional generation supply, but the reverse energy created by solar/wind renewables creates fluctuating voltages escalation within the distribution grid, thereby presenting potential grid safety and grid reliability concerns for electric distribution utility operators.

The intra-grid sensors now reveal unplanned loading impacts due to known/unknown EV charging stations, known/unknown Power Theft, and known/unknown legalized recreational marijuana growing. As a result, intra-grid sensors now enable grid operators to identify and reduce the unplanned loading impact on distribution transformers and related grid assets by stopping power theft, and/or re-sizing transformer assets to absorb the increasing unplanned load now stemming from increasing EV charging station penetration and the substantial impact of recreational marijuana growing, thus helping to avoid unnecessary/costly power outages. This proactive understanding and remediation by grid operators of previously unknown intra-grid loading issues results in fewer unplanned truck rolls for utilities, thus further contributing to GHG reduction due to unplanned truck roll fuel emissions being lessened.

Distributed energy resources (DER) as noted above now provide energy into the distribution grid from a non-traditional generation source (i.e., grid-edge renewables). This influx of energy coming onto the distribution grid from the grid-edge is environmentally beneficial, but it does create potentially serious, unexpected voltages impacts within the impacted area(s) of DER energy influx. Intra-grid sensors not only provide utility operators with improved vision to understand the DER safety related impacts upon the grid, but they will also be used to empirically quantify the amount of reverse energy (reverse kilowatt hours) being provided into the grid at the distribution transformer level, thereby representing an accurately measured/monitored aggregation of downstream DER contributors which may include one or more reverse energy contributors pushing reverse energy onto the grid at the respective distribution transformer(s).

The value of understanding this reverse energy created via DER is two-fold for grid operators. First, by capitalizing upon the highly accurate bi-directional current sensor capability of intra-grid sensors, operators will now have an accurate understanding of the quantity of DER-induced reverse energy levels entering their distribution grids which may be used to create financial compensation models (e.g., net metering, paying for renewable energy contribution, etc.) for applicable rate payers who have invested in grid-edge DER installations. Secondly, the recorded DER-produced reverse energy contribution measured at the distribution transformer(s) also presents an offset in upstream traditional electricity generation demand. In other words, given the empirical understanding of reverse energy being imparted into the distribution grid via DER occurring at the grid-edge, utility operators can now quantify the reduced energy demand required to be delivered by traditional generation, due to this supplemental DER-induced reverse energy supply. This empirically captured reverse energy information aggregated at the transformer(s) by the intra-grid sensors represents a reduction in GHG emissions by quantifying the related offset reduction of traditional generation levels due to: a) DER energy contribution at the grid-edge, and b) the reduced technical loss impact which inherently occurs within both the distribution grid and the transmission grid thereby collectively requiring extra generation supply to be used to compensate for unavoidable, inherent technical loss. In other words, whenever less energy is required to be provided by traditional generation (e.g., due to DER-induced reverse energy), increased energy efficiency created in the distribution grid plus associated reduced Technical Loss impact, etc., there is a reduction savings and therefore generation reductions that result in reduced GHG emissions.

It is important to note that energy efficiency gains achieved within the distribution grid create traditional generation-level GHG reductions due to: a) the distribution grid inefficiencies reduction empowered by the identification and remediation of non-technical loss via intra-grid sensors, b) the distribution grid technical loss reduction which inherently occurs but will be lessened as the amount of energy required to supply the distribution grid is reduced via energy efficiency improvements when remediating non-technical loss, and c) the transmission grid technical loss reduction as less energy will be required from generation to serve the improved energy efficiency being created within the distribution grid, thereby enabling the inherent technical loss occurring in the transmission grid to also be lessened.

Notably, utility leaders may be encouraged and/or required to reduce GHG by legal mandate, public pressure, and/or customer expectation. Given that approximately 65% of all GHG emissions in the United States of America (and globally) is due to electricity generation produced via fossil fuel sources, it is critical that to prove how electric distribution utilities globally can: a) reduce identifiable energy inefficiency/waste non-technical loss within distribution grids, b) reduce excessive voltages associated with over-energizing circuit feeders or entire distribution grids, c) safely embrace DER, d) accurately monitor reverse energy kilowatt hours entering their distribution grids, e) reduce technical loss in the distribution and transmission grids as a result of improved energy efficiency within the distribution grid, and f) safely embrace EV charging stations for the collective purpose of creating a comprehensive GHG reduction formula using the data and multi-purpose value opportunities presented by intra-grid sensors.

Although clean energy sources are expanding, many jurisdictions are substantially coal power and/or fossil fuel power rich regarding electricity generation as either their primary or backup supply sources. Therefore, every kilowatt hour of unnecessarily generated and/or wasted energy relating to non-technical Loss that can be eliminated from any distribution grid via intra-grid sensors, plus the associated technical loss that can be reduced within both the distribution and transmission grid represents a meaningful GHG reduction improvement. And, every grid that can be safely stabilized/monitored to properly absorb DER, and EV charging station penetration further lessens GHG emissions impact throughout the globe.

The intra-grid sensor can enable electric distribution utilities to become notable leaders in the quest to achieve GHG emissions reduction. Grid operators can lessen energy waste and energy inefficiencies within distribution grids which is now identifiable and remediable by using the intra-grid sensor technology, thus lowering generation-related and unnecessary truck rolls-related GHG emissions, and creating valuable conservation gains for North America, and globally.

Additionally, the multiple GHG reductions facilitated using intra-grid sensors also leads to carbon emission reduction (CER) credits. Thus, energy efficiency improvements achieved by grid operators will present a potential financial gain as the CER credits market develops on a localized, nationalized, and/or global commodity basis.

The GHG reduction can be accomplished by the intra-grid sensor devices that are used to empirically prove and directly identify energy loss/waste, and identify excessive voltages, and indirectly support beneficial and safe adoption of DER and EV's, collectively driving empirically supported, significant GHG reductions.

The intra-grid sensors create a meaningful GHG reduction solution to be employed within electric distribution grids throughout North America and globally especially given imminent electrification regarding Electric Vehicles (EVs), the increasing occurrence of DER uptake, the need to locate/remediate costly Power Theft, and to create an effective solution for achieving “In Front of the Meter Conservation” (i.e., IFMC).

Many or possibly most electric distribution utilities facilitate millions of metric tons of GHG emissions due solely to serving unnecessary energy loss/waste (i.e., Non-Technical Loss). This means that now-avoidable electricity generation is required to provide the extra energy to serve the intra-grid inefficiency/waste occurring annually within the electric distribution grids, plus the associated Technical Loss within the distribution and transmission grids to support the Non-Technical Loss (i.e., energy inefficiency/waste). This historic but now avoidable practice produces millions of metric tons of GHG emissions that can now be avoided via the use of intra-grid sensors.

In addition, excessive voltages may be discovered within many or possibly most distribution grids thus identifying circuit feeders which can benefit from the implementation of Volt/Var such as conservation voltage reduction (CVR); excessive voltages are present within most North American grids (just as they are globally), and the correction of this intra-grid condition will lessen energy inefficiency/waste, and will further increase the effectiveness of the intra-grid sensor facilitated GHG reduction efforts by now locating and remediating excessive voltages within the grids. Intra-grid sensors will simultaneously address energy loss/waste, excessive voltages/waste, and indirect impacts associated with DER and EV charging stations plus Power Theft and other avoidable Non-Technical Loss sources, thus facilitating a unique, comprehensive, and effective GHG reduction solution.

Therefore, using intra-grid sensors to facilitate the reduction of potentially millions of metric tons of GHG associated purely with energy loss/waste, we estimate the ability to lessen the associated GHG impact by upwards of 50% or greater depending upon various grid conditions and nuances. This belief is because “Line Loss” as is defined in today's industry presently includes now-avoidable non-technical loss plus now-avoidable Technical Loss revealed by intra-grid sensors which is not due to inherent technical loss, and is now able to be remediated due to intra-grid sensor technology.

A system in accordance with an embodiment of the present disclosure identifies technical loss (including correctable and non-correctable), correctable Non-Technical Loss, and over-energized inefficiency-related Loss. The identification of these remediable Loss sources/instances is in turn used by utility operators to resolve the associated now avoidable energy inefficiency/waste. The correctable Loss and inefficiency Loss (e.g., over-energized grid and/or grid segments, over-sized transformers, etc.) identified by intra-grid sensors is then used to effectuate Greenhouse Gas (GHG) emission reductions, which are then used to seek carbon emission reduction (CER) credits.

Note that most utilities send enough energy into their distribution grid to serve actual energy demand, plus inherent technical line loss, plus correctable non-technical and technical loss; noting that some utility operators over-energize the distribution grid which creates additional energy inefficiency/waste loss.

When non-technical loss and inefficiency-induced technical loss are identified, quantified and remediated, the utilities may then decrease the power introduced to the distribution grid such that inherent Technical Loss that occurs on both transmission and distribution lines can be reduced because the correctable non-technical loss and inefficiency Loss becomes reduced, resulting in less power being required to be injected into the transmission and the distribution grids. Notably, the reduction of power being injected into the transmission grid will result because less power will be required at the distribution grid once the correctable Non-Technical Loss and the associated Technical Loss inefficiencies are remediated. That is, when correctable non-technical loss and associated technical loss are remediated, overall energy demand decreases within the distribution grid, which causes less energy to be introduced into the upstream transmission space from the upstream generation source. Thus, leading to GHG emissions reduction which can then be converted to CER credits.

Furthermore, a system in accordance with an embodiment of the present disclosure accurately collects data indicative of kilowatt hours of reverse energy (due to Photovoltaic, or PV) being driven into the distribution grid at the transformer level. Such empirically collected data indicates an offset in traditional generation leading to a reduction in GHG emissions, which can then be converted to CER credits.

The intra-grid sensors of the present disclosure, described accurately measure data at the secondary side of distribution transformers; key areas such as but not limited to forward energy, reverse energy, voltages, current, and ambient temperature at the transformer are captured at various intervals, encrypted, and then reported via cellular and/or RF Mesh communications. Onboard communications options which may include Global Standard for Mobile (GSM), versions of long term evolution (LTE), radio Frequency (RF), serve to backhaul critical, timely, accurate, intra-grid data to our distributed network protocol (DNP3)-enabled secure headend, and/or to an advanced metering infrastructure (AMI) or alternative third party mobile device management (MDM), and/or to a utility supervisory control and data acquisition system (SCADA) platform, and/or to other utility operating systems. The proprietary headend dashboard and advanced analytics modules afford electric distribution utilities/local distribution companies (LDCs) the ability to identify significant energy Loss (e.g., technical, non-Technical, inefficiency due to over-energizing, transformer over-sizing, etc.), provide automated alerts to operators when intra-grid conditions exceed (i.e., high or low) expected and/or desired intra-grid tolerances, automatically notify grid operators of power outages and power restoration, and impact a vast list of distribution grid optimization, conservation and automation efficiencies.

The patented intra-grid sensor devices are specifically designed with North American electric utility/LDC input to provide the easiest and fastest to install intra-grid sensors presently available on the global market—most single-phase transformer installations are commonly achieved in less than 7-10 total minutes. Patented intra-grid sensors provide the most accurate and the most wide-ranging capability of any presently known intra-grid sensors in the market, thus providing exceptional accuracy and data confidence for grid operators. Patented intra-grid sensors attach safely and effectively to single phase and poly phase distribution transformers, and are designed for pole mount, pad mount, vault, and submersible transformer applications. De-energizing of the transformer or distribution grid is not required when using such patented intra-grid sensors.

The intra-grid sensors are affixed to distribution transformers within and/or throughout a targeted circuit feeder and/or entire grid locations. The intra-grid sensors produce unique, accurate, timely, granular, reliable data feeds from within the distribution grid. This intra-grid data is used to identify sources of energy inefficiency/waste for remediation, and/or to empirically record and/or extrapolate kilowatt hour savings and/or DER-induced reverse energy from within the distribution grid upstream through the transmission grid and ultimately to the generation level. This intra-grid data is used to identify GHG emissions reduction opportunity value. And, associated CER credits value can also then be derived.

This unique intra-grid sensor data feed is unparalleled. Given the combination of unique data, and automated alert capability, the intra-grid sensors accurately locate wasted energy (e.g., avoidable technical loss, avoidable non-technical loss, excessive voltages, over-sized transformers, etc.), and locate unplanned and/or otherwise unknown loading impacts (e.g., EV charging stations, legalized marijuana, power theft, etc.), and identify voltage impacts from DER, and accurately monitor/report reverse energy creating battery storage planning capabilities, and reduce unplanned outages (i.e., further reducing GHG via fewer unplanned truck rolls).

Intra-grid sensors will identify much of this now avoidable non-technical loss and avoidable associated technical loss, which represents ‘wasted/excessive’ energy being inefficiently pushed into and through the grid (i.e., distribution and transmission), but never arriving at ratepayer meters.

Once energy inefficiency is located via intra-grid sensors and remediated by grid operators, less generation is required to satisfy the present combination of ratepayer need plus energy loss/waste within the grid, plus excessive energy, plus less technical loss associated with the distribution (and transmission) of electricity presently serving these now remediable non-technical loss, avoidable technical loss, and associated excessive energy inefficiencies/waste. By removing energy waste, we create efficiencies and that will result in less generation demand, thereby resulting in decreased GHG emissions.

Intra-grid sensors will enable the distribution grid operators to reduce unnecessary line loss and gain distribution grid energy efficiencies and operations efficiencies. In this regard, grid operators may be able to realize an estimated 30% to 50% or more reduction in their historic/present line loss after they have implemented the necessary changes and remediation processes required to reduce their identified losses and identified energy inefficiencies.

Although, there will obviously be a direct power purchase benefit for grid operators to reduce their distribution Line Loss, it will also in turn reduce the generation demand required to service the associated distribution (and transmission) grid(s). If a grid operator can reduce generation demand, then it is in-fact reducing the GHG emissions which is emitted during fossil fuel-based power generation. By using intra-grid sensors to quantify and verify the grid efficiencies realized by the amount of kilowatt hours saved thru identification of distribution grid energy inefficiencies/waste (and associated transmission grid energy loss/waste), the system of the present disclosure can subsequently model and quantify how much GHG is reduced by the grid operator to offset traditional generation-related GHG emissions, and subsequently facilitate Carbon Emissions Reduction (CER) credits calculations.

Depending upon factors such as which jurisdiction the grid operator is operating, what type of GHG emissions reduction target scheme is/is not in place, whether it is a non-regulated jurisdiction, a carbon tax jurisdiction, or a cap and trade jurisdiction, the opportunities available to the grid operator may differ as per the governing regulatory policies.

However, in general it is reasonable to assume that by quantifying the amount of kilowatt hours that a distribution grid operator has reduced in its line loss, thereby leading to a lesser upstream generation demand, then the applicable amount of generation reduction measured in some version of kilowatt hours should qualify for a carbon emission reduction (CER) credit as per the respective governing policy. (Presently, the industry defines “Line Loss” as a combination of Technical Loss and Non-Technical Loss, that collectively represents ‘energy inefficiency’. Intra-grid sensors target the identification of non-technical Loss and certain technical inefficiency loss by which the remediation of such correctable Loss/inefficiencies will yield GHG reduction.

The data that the intra-grid sensors capture enables utilities to construct the energy efficiencies improvement model and then convert quantified and/or extrapolated energy savings results into GHG reductions. Through carbon advisory services the grid operator can undertake all necessary work to apply for the carbon emission reduction (CER) credits generated by the grid efficiencies gained using intra-grid sensors.

Grid operators that have a significant residential and/or commercial and/or industrial DER solar PV component within their distribution grid will likely experience higher GHG offsets (and subsequent Carbon Emissions Reduction credits), because these DER-induced grid-edge solar PV locations are producing energy that intra-grid sensors can accurately measure, as this reverse energy is being injected back into the grid at the distribution transformers location(s).

DER-induced Solar PV arrays are environmentally friendly and help in reducing GHG emissions that would have otherwise occurred due to the traditional fossil fuel-based power generation. If the Solar PV array starts injecting electricity into the grid, this reverse energy can help to displace an equal amount of electricity that otherwise would have been traditionally generated to serve the traditionally GHG intensive grid. Many or possibly most of the power grids in the United States and globally are served and/or backed up by varying degrees of electricity that is generated from fossil fuel-based power plants). Hence, intra-grid sensor facilitated projects/investments will become eligible to earn Carbon Emission Reduction (CER) credits under the UNFCCC Clean Development Mechanism (CDM).

State/Federal/Province/Territory jurisdictions will provide incentives to residential/commercial/industrial electric customers to install DER-induced Solar PV (and/or localized wind generation) to reduce fossil fuel power generation demands and increase clean/green energy supply. These incentives are generally in the form of nonrefundable Tax Credits for 30% up to 50% of a DER-induced Solar PV panel (and/or localized wind source) installation and/or mandated energy buyback for a predetermined price per kilowatt hour that is sold back to the grid operator by the end user who is producing the renewable energy. Notably, the buyback price is higher than the standard residential electricity rate charged by the grid operator for kilowatt hours of grid supplied energy so there is a net gain for the end user who has invested in Distributed Energy Resources (DER).

Regardless of the incentive provided, the customer is being rewarded for the electricity they generate with their DER-induced Solar PV array (and/or localized wind source) and that derived energy savings is what the end user is entitled to receive; Noting that the end use may not be entitled to receive the associated CER credits.

However, if we consider that the electric distribution grid operator has made it possible to reduce the overall power generation demand by accepting residential/commercial/industrial DER-induced Solar PV arrays from their ratepayers which then offsets generation demand, then grid operators have in fact reduced the amount of carbon-based generation required to previously supply their customers before the introduction of DER-induced Solar PV supply. There is a two-fold effect because the customer is now generating their own electricity which no longer has to be supplied by the utility via standard traditional generation practice which commensurately reduces demand (including peak energy supply and cost burdens for the grid operator). Secondly, the excess DER-induced Solar PV is being pushed back to the circuit feeders via the grid operator's distribution transformer(s) and used elsewhere within the distribution grid by other consumers which further reduces traditional generation demand including peak load.

The end user who produces the renewable energy may already be being paid for their DER-induced Solar PV energy (or localized wind) via a utility-provided compensation scheme (e.g., Net metering, buyback of excessive DER energy provided into the distribution grid, etc.), and in such cases would not claim any CER credits. But the grid operators—via their own or their jurisdiction's policy—that actively allow DER-induced Solar PV (or localized wind) are therefore reducing the Carbon-based traditional generation and thus reducing the amount of Carbon Dioxide (CO2) emissions, commonly measured in Tons (or metric Tonnes) that they are typically emitting via traditional generation. These GHG reductions do qualify for the CER credits programs as determined by various markets/jurisdictions.

Aggregated (and/or extrapolated) data of how much DER-induced Solar PV (or localized wind) electricity generated both for the residential/commercial/industrial customer's own use, plus the amount of excess DER-induced Solar PV (or localized wind) electricity that was pushed back onto the operator's grid (as captured and reported by intra-grid sensors. This total amount of DER-induced Solar PV (or localized wind) generated electricity within the respective grid(s) may need to be quantified, qualified, verified and modeled by an independent recognized authority under direction of local jurisdiction requirements, as afforded by using intra-grid sensor data.

By creating jurisdiction-approved GHG emissions reduction models facilitated by intra-grid sensor empirical data documentation of Non-Technical Loss, the reduction of excessive/over-energized grid Loss, related avoidable Technical Loss in the distribution and Transmission grids, and the accumulated kilowatt hour offsets driven by DER renewables (e.g., solar, wind, geothermal), grid operators will possess a pathway to document intra-grid related Carbon Emission Reductions (CERs). This will enable grid operators to be awarded the commensurate CER credits, and/or the grid operator can assign these earned CER credits to a third party, as may be applicable via a Federal or State scheme or perhaps under the UN Framework Convention on Climate Change (UNFCCC) Paris Accord with the Clean Development Mechanism (CDM).

A GHG emissions target refers to the emission reduction levels that states set out to achieve by a specified time. For example, a state may set a target of reducing emissions to 1990 levels by 2020, and to 50 percent below 1990 levels by 2050.

States use a variety of baseline years, ranging from 1990 to 2006, and a few different years for the ultimate target, ranging from 2020 to 2050. Most states have a common ultimate target year of 2050.

There are two main types of carbon pricing: emissions trading systems (ETS), and carbon taxes.

An ETS, often referred to as cap-and-trade system, caps the total level of GHG emissions and allows those industries with low emissions to sell their extra allowances to larger emitters. By creating supply and demand for emissions allowances, an ETS establishes a market price for greenhouse gas emissions. The cap helps to ensure that the required emission reductions will take place to keep the emitters (in aggregate) within their pre-allocated carbon budget.

A Carbon Tax sets a price on carbon by defining a tax rate on GHG emissions or—more commonly—on the carbon content of fossil fuels. It is different from an ETS in that the emission reduction outcome of a carbon tax is not pre-defined but the carbon price is.

The choice of the instrument will depend on national and economic circumstances. There are also more indirect ways of more accurately pricing carbon, such as through fuel taxes, the removal of fossil fuel subsidies, and regulations that may incorporate a “social cost of carbon.” Greenhouse gas emissions can also be priced through payments for emission reductions. Private entities or sovereigns can purchase emission reductions to compensate for their own emissions (so-called offsets) or to support mitigation activities through results-based finance.

Some 40 countries and more than 20 cities, 24 states and 3 provinces already use carbon pricing mechanisms, with more planning to implement them in the future. Together the carbon pricing schemes now in place cover about half their emissions, which translates to about 13 percent of annual global greenhouse gas emissions.

Please note based upon conservative assumptions our intra-grid Sensor devices can identify distribution grid inefficiencies and enable utilities to reduce at least 2% of the excess power generation in the United States/Canada based upon the average 6% per annum of energy distribution losses reported by electric utilities.

If you take the US EPA published statistic of Carbon Dioxide (CO2) generated in year 2016 for electric production in the USA of 1,928,401,000 metric tons and take just 2% of that amount you get 38,568,020 tons of carbon reduction. So, the USA in total should qualify for an amount of USD 424,248,220 dollars a year based on today's carbon credit value of USD $11.00 per metric ton. So, over an expected intra-grid sensor service lifespan of 10 years of power reduction savings we can extrapolate that we would generate USD $4,242,482,200 (4.242 billion dollars) of carbon credits in total for all the USA electric distribution utilities.

Please Note the Carbon Credit Assumptions I have taken in proposal & financial feasibility calculations: Clean Development Mechanism (CDM) Benefit: from 2nd year to 15th year (@ 1 CER=11 USD)

International and domestic regulations relating to climate change, following the Kyoto Protocol of the UN Framework Convention on Climate Change (UNFCCC) and subsequent international negotiations, are also expected to generate revenue streams for the project by way of Certified Emissions Reduction (CER) rights, credits or units.

The trading of Certified Emissions Reduction (CER) rights, credits, or units, within or outside the envisaged Clean Development Mechanism (CDM), is a possibility for Carbon Dioxide (CO2) equivalent reductions achieved by the reduction of electric power generation using fossil fuels. These revenue streams are now possible due to the implementation of the international treaties currently under negotiation with member countries.

Certified Emission Reduction Credit has been conservatively assumed to be 0.00906 USD per kWh (unit) this is equal to around $11.00 USD per CER, this will change over time, as the CER are traded around the world, but our assumption is a safe figure to use.

The prevailing market rate for carbon credit is approximately USD $12.00-$22.00 per ton per CER. However, for the cash flow assumptions it is assumed conservatively at only USD $11.00 per CER per calculation given below:

1 kWh (unit) is calculated to reduce CO2 emissions by 0.535 Kg (for a USA average fuel mix).

1000 units (1000 kWh)=1000*0.535=535 Kg is equivalent to 0.535 CER.

0.535 CER*USD11=USD $5.885 per 1000 kWh

As per United Nations Framework Convention on Climate Change (UNFCCC) the weightage factor for the USA grid is 0.916 hence, the actual revenue realization per unit=5.885*0.916=USD $5.391.

15% is assumed towards expenses and consultancy charges for CDM registration and sale of carbon credit. Hence the net realization will be approximately USD 4.582 per unit.

The carbon credit income is assumed at USD 6.00 per CER during the 1st year because the registration process may take about one year.

For fossil fuel only generation, the following applies:

1 kWh (unit) is calculated to reduce CO2 emissions by 1.003 Kg (for a USA fossil fuel).

1000 units (1000 kWh)=1000*1.003=1,003 Kg is equivalent to 1.003 CER.

1.003 CER*USD11=USD $11.033 per 1000 kWh

As per UNFCCC the weightage factor for the USA grid is .916 hence, the actual revenue realization per unit=$11.033*0.916=USD $10.11.

15% is assumed towards expenses and consultancy charges for CDM registration and sale of carbon credit. Hence the net realization will be approximately USD 8.59 per unit.

Calculating carbon emission reduction credits varies from sector to sector. First a baseline is established. To get the baseline, calculate the amount of emissions that would be emitted in the absence of projects to take care of pollution. For instance, you measure the number of megawatts versus emissions from a co-generation power plant and compare it with a Solar PV, which is a zero-emission plant. One credit or CER is equivalent to one Ton (US Metric Ton 1000 kg) of emission reduced.

Carbon credit is a carbon credit irrespective of from where it is produced. Of course, entities would like to deal with trustworthy counter parties or with developers or sellers in a country that is dynamic in expediting the approval of these projects.

The US accounts for 25-30% of all global emissions and there are 24 States that have implemented some form of greenhouse gas reduction targets, either through Cap and Trade or through a Carbon Tax.

Developing a new offset project involves:
1) Reviewing regulations and investment considerations for the specific jurisdiction in which the project will be located and selecting which GHG Scheme to apply under if it has more than one possible GHG program to choose from.
2) Creating a project plan using contracted subject matter experts.
3) Validating the plan with industry experts, engineers, accountants.
4) Submitting the plan for acceptance with the jurisdictional authorities.
5) Have the jurisdictional authority officially commission the project.

Managing an existing project involves:
1) Monitoring project activity and begin collecting the data through our auditing activities.
2) Producing regular project reports and start the project modeling work to scientifically prove and quantify the GHG reductions potential of the project.
3) Seeking verification of the reports and third-party testing and certifications.
4) Work with the utility to monitor and execute the remediation steps to gain the audited efficiency potential.
5) Re-audit to verify and prove the actual efficiencies realized through reduced demand and GHG generation reductions attained.
6) Applying for the issuance of offset units or GHG emission reductions credits.
7) Managing the GHG emission reduction credits, through the entire 8 to 10-year project term, or pre-sale of scripts to interested third parties at a discounted rate.

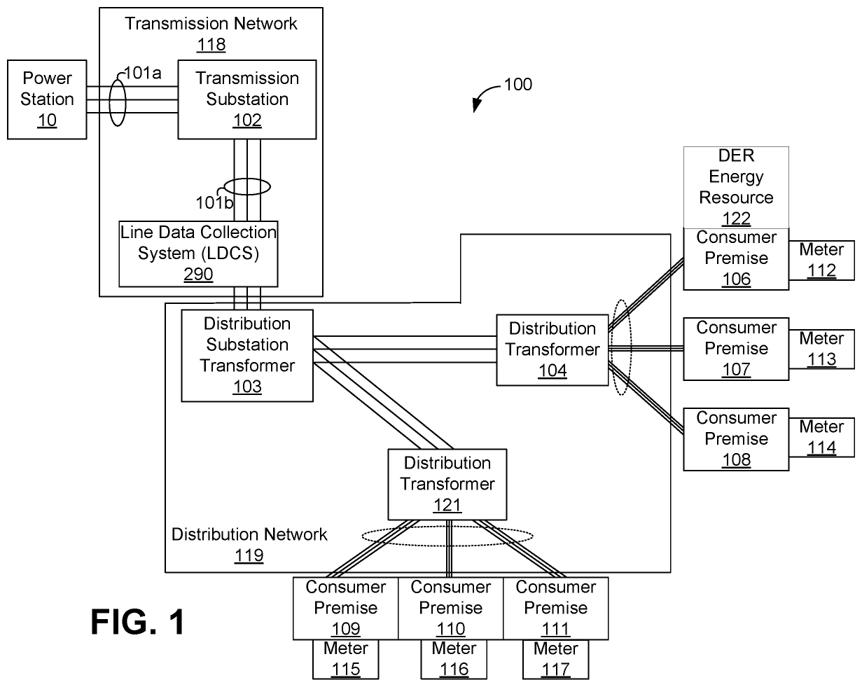

FIG. 1 is a block diagram illustrating a power transmission and distribution system 100 for delivering electrical power to one or more consumer premises 106-111. The one or more consumer premises 106-111 may be business consumer premises, residential consumer premises, or any other type of consumer premise. A consumer premise is any structure or area to which power is delivered.

The power transmission and distribution system 100 comprises at least one transmission network 118, at least one distribution network 119, and the consumer premises 106-111 interconnected via a plurality of power lines. Additionally, the power transmission and distribution system 100 comprises at least one distributed energy resource 122, which can be solar, wind, nuclear, or any other type of power source, that provides reverse energy to the distribution network 119.

The power transmission and distribution system 100 is an electric “grid” for delivering electricity generated by a power station 10 to the one or more consumer premises 106-111 via the transmission network 118 and the distribution network 119. In this regard, the power station 10 generates power or creates power and sends the power created or generated to the transmission network 118. The transmitted energy from the power station 10 is extremely high voltage power.

The transmission network 118 comprises one or more transmission substation 102 (only one is shown for simplicity). The power station 10 is electrically coupled to the transmission substation 102, and the transmission substation 102 is electrically connected to the distribution network 119.

At the power station 10, electricity is generated, and the voltage level of the generated electricity is “stepped up,” i.e., the voltage of the generated power is increased to high voltage (e.g., 110 kV or greater), to decrease the amount of losses that may occur during transmission of the generated electricity through the transmission network 118.

The distribution network 119 transmits electricity from the transmission network 118 to the consumer premises 106-111. In this regard, the distribution network 119 comprises a distribution substation transformer 103 and one or more distribution transformers 104 and 121. Note that the configuration shown in FIG. 1 comprising the distribution substation transformer 103 and two distribution transformers 104 and 121 and showing the distribution substation transformer 103 physically separated from the two distribution transformers 104 and 121 is an exemplary configuration. Other configurations are possible in other embodiments.

The distribution substation transformer 103 is shown electrically coupled to two distribution transformers 104 and 121. Note that most distribution substation transformer 103 services anywhere from three to five distribution transformers; however, only two are shown for simplicity.

When the electricity is received, the distribution substation transformer 103 decreases the voltage of the electricity to a range that is useable by the distribution transformers 104, 121. Likewise, the distribution transformers 104, 121 may further decrease the voltage of the electricity received to a range that is useable by the respective electrical systems (not shown) of the consumer premises 106-111.

In one embodiment of the present disclosure, the distribution transformers 104, 121 are electrically coupled to intra-grid sensors. The intra-grid sensors of the present disclosure comprise one or more electrical devices that measure operational data via one or more electrical interfaces with the distribution transformers 104, 121. Exemplary operational data includes data related to electricity transmitted from the distribution transformers 104, 121, e.g., power measurements, energy measurements, voltage measurements, current measurements, etc. The operational data may also include data indicative of reverse power or power received from energy sources on the customer premises, e.g., solar or wind power. In addition, the intra-grid sensors collect operational data related to the environment in which the distribution transformers 104, 121 are situated, e.g., operating temperature of the distribution transformers 104, 121.

Furthermore, each consumer premise 106-111 comprises an electrical system (not shown) for delivering electricity received from the distribution transformers 104, 121 to one or more electrical ports (not shown) of the consumer premise 106-111. Note that the electrical ports may be internal or external ports.

The electrical system of each consumer premise 106-111 interfaces with a corresponding consumer premise's electrical meter 112-117, respectively. Each electrical meter 112-117 measures the amount of electricity consumed by or received from the consumer premises' electrical system to which it is coupled. To charge a customer who is responsible for the consumer premise, a power company (e.g., a utility company or a metering company) retrieves data indicative of the measurements made by the electrical meters 112-117 and uses such measurements to determine the consumer's invoice dollar amount representative of how much electricity has been consumed at the consumer premise 106-111. Notably, readings taken from the meters 112-117 reflect the actual amount of power consumed by the respective consumer premise electrical system. Thus, in one embodiment of the present disclosure, the meters 112-117 store data indicative of the power consumed by the consumers.

As described hereinabove, the consumer premises may have solar panels, energy producing wind implements, or any other means of distributed energy resource (DER) systems. In such an embodiment, the alternative energy source may inject energy into the distribution network 119 instead of consuming it. In this regard, FIG. 1 depicts a distributed energy resource 122 at the consumer premise 106. In such an embodiment, the DER 122 may be installed such that the meter 112 meters the injected energy, which is then detected by the transformer monitoring device 244. Note that only one DER 122 is shown, but a plurality of DERs may be used in other embodiments of the system 100.

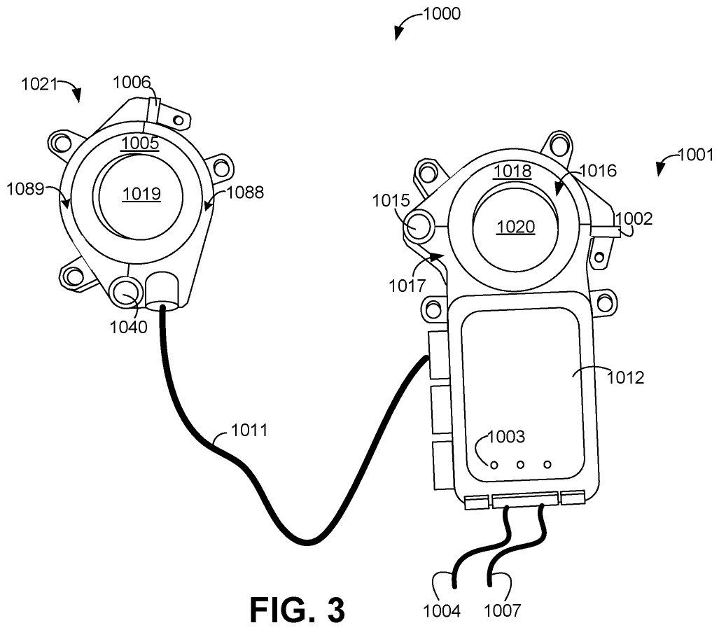

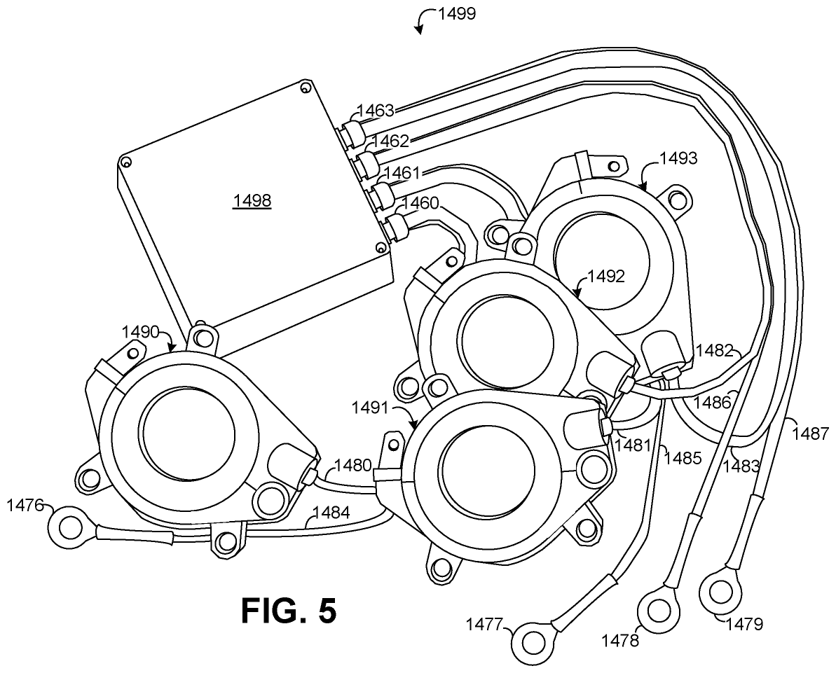

Note that the intra-grid sensors are any type of monitoring device that collects operational data from the distribution transformer. FIGS. 3 and 5 depicts exemplary intra-grid sensors.

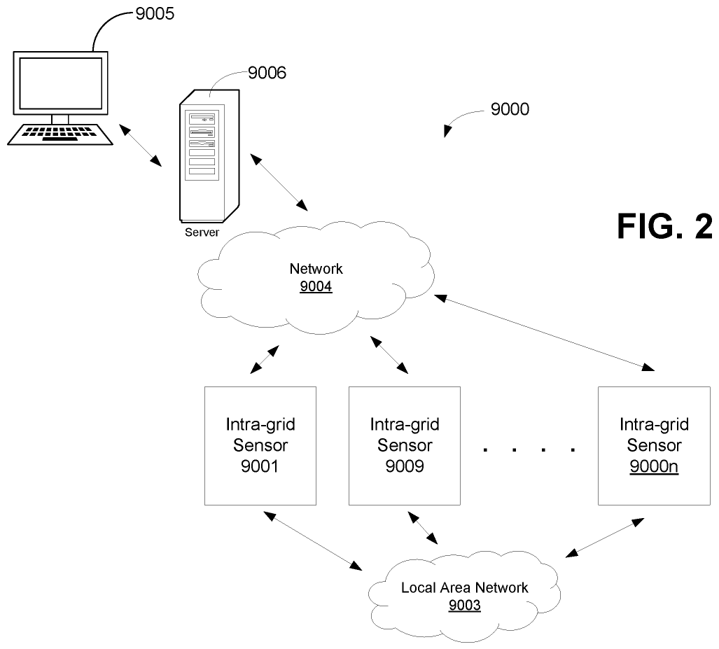

FIG. 2 is a system for identifying GHG emission reductions and carbon emission credits 9000. The system for identifying greenhouse gas emission reductions and carbon emission credits 9000 comprises a plurality of intra-grid sensors 9001-9000ₙ, a server 9006 and an operator's terminal 9005. Note that FIG. 2 further depicts a wide area network (WAN) 9003 that may be used in one embodiment to transmit data from one intra-grid sensor to another intra-grid sensor. In one embodiment, this network is a mesh network. Note that this wide area network is an optional feature. Further note that in one embodiment, the WAN may be configured to transmit data over the network 9004 to the server 9006.

Each intra-grid sensor 9001-9000n is coupled to a secondary side of a distribution transformer. This is often referred to as the output side of the distribution transformer. Notably, each distribution transformer receives power on its primary side, which is often referred to as the input side of the distribution transformer. In this regard, power comes into the transformer on the primary side and emanates from the secondary side to a receiving source, e.g., a consumer meter. Each intra-grid sensor 9001-9000n comprises a component for collecting data related to current, and each intra-grid sensor 9001-9000n comprises a component for collecting data related to voltage. The intra-grid sensor s 9001-9000n may further have other sensors or devices for collection other data in other embodiments.

Each intra-grid sensors 9001-9000n is communicatively coupled to the server 9006 via network 9004. Thus, any data collected by the intra-grid sensors 9001-9000n is transmitted through the network 9004 to the server 9006, and any data received by the server 9006 may be viewed by an operator (not show).

In operation, the intra-grid sensors 9001-9000n collect operational data related to their respective transformer. The data collected is transmitted to the server 9006. The server 9006 uses the data received to identify non-technical and technical loss in the grid. Further, the server 9006 may calculate GHG and corresponding CERs.

As an example, intra-grid sensor 9001 collects data related to power transmitted down the line to a plurality of endpoints (or meters). The intra-grid sensor 9001 transmits data indicative of the power out via the network 9004 to the server 9006. The server 9006 comprises data indicative of the amount of power metered at the endpoint. The server compares the data received from the intra-grid sensor to the data indicative of metered power at the endpoint. If the power from the transformer is substantially more than the power metered at the endpoint, the server transmits data notifying the operator of the terminal 9005 of the discrepancy.

FIG. 3 depicts an embodiment of a general-purpose transformer monitoring device 1000 that may be used as the intra-grid sensor in the system 2000 (FIG.2). The transformer monitoring device 1000 may be installed on conductor cables (not shown) and used to collect data indicative of voltage and/or current from the conductor cables to which it is coupled.

The general-purpose transformer monitoring device 1000 comprises a satellite unit 1021 that is electrically coupled to a main unit 1001. In one embodiment, the satellite unit 1021 is coupled via a cable 1011. However, the satellite unit 1021 may be coupled other ways in other embodiments, e.g., wirelessly. The general-purpose transformer monitoring device 1000 may be used in many different methods to collect voltage and/or current data from the distribution transformers 103, 104 (FIG. 1).

To collect voltage and/or current data, the satellite unit 1021 and/or the main unit 1001 is installed around a conductor cable or connectors of conductor cables (also known as a “bushing”). The satellite unit 1021 of the general-purpose transformer monitoring device 1000 comprises two sections 1088 and 1089 that are hingedly coupled at hinge 1040. When installed and in a closed position (as shown in FIG. 3), the sections 1088 and 1089 connect via a latch 1006 and the conductor cable runs through an opening 1019 formed by coupling the sections 1088 and 1089.

The satellite unit 1021 further comprises a sensing unit housing 1005 that houses a current detection device (not shown) for sensing current flowing through the conductor cable around which the sections 1088 and 1089 are installed. In one embodiment, the current detection device may comprise an implementation of one or more coreless current sensor as described in U.S. Pat. No. 7,940,039, which is incorporated herein by reference.

The main unit 1001 comprises sections 1016 and 1017 that are hingedly coupled at hinge 1015. When installed and in a closed position (as shown in FIG. 3), the sections 1016 and 1017 connect via a latch 1002 and a conductor cable runs through an opening 1020 formed by coupling the sections 1016 and 1017.

The main unit 1001 comprises a sensing unit housing section 1018 that houses a current detection device (not shown) for sensing current flowing through the conductor cable around which the sections 1016 and 1017 are installed. As described hereinabove with respect to the satellite unit 1021, the current detection device may comprise an implementation of one or more Rogowski coils as described in U.S. Pat. No. 7,940,039, which is incorporated herein by reference.

Unlike the satellite unit 1021, the main unit section 1001 comprises an extended boxlike housing section 1012. Within the housing section 1012 resides one or more printed circuit boards (PCB) (not shown), semiconductor chips (not shown), and/or other electronics (not shown) for performing operations related to the general-purpose transformer monitoring device 1000. In one embodiment, the housing section 1012 is a substantially rectangular housing; however, differently sized, and differently shaped housings may be used in other embodiments.

Additionally, the main unit 1001 further comprises one or more cables 1004, 1007. The cables 1004, 1007 may be coupled to a conductor cable or corresponding bus bars (not shown) and ground or reference voltage conductor (not shown), respectively, for the corresponding conductor cable, which will be described further herein.

Note that methods in accordance with an embodiment of the present disclosure use the described monitoring device 1000 for collecting current and/or voltage data. Due to the noninvasive method of installing the satellite unit and main unit around a conductor and connecting the leads 1004, 1007 to connection points, an operator (or utility personnel) need not de-energize a transformer 103, 104, 121 (FIG. 1) for connection or coupling thereto. Further, no piercing (or other invasive technique) of the electrical line is needed during deployment to the power grid. Thus, the monitoring device 1000 is easy to install. Thus, deployment to the power grid is easy to effectuate.

During operation, the satellite unit 1021 and/or the main unit 1001 collects data indicative of current through a conductor cable. The satellite unit 1021 transmits its collected data via the cable 1011 to the main unit 1001. Additionally, the cables 1004, 1007 may be used to collect data indicative of voltage corresponding to a conductor cable about which the satellite unit is installed. The data indicative of the current and voltage sensed corresponding to the conductor may be used to calculate power usage.

As indicated hereinabove, there are many different methods that may be employed using the general-purpose monitoring device 1000 to collect current and/or voltage data and calculate power usage.

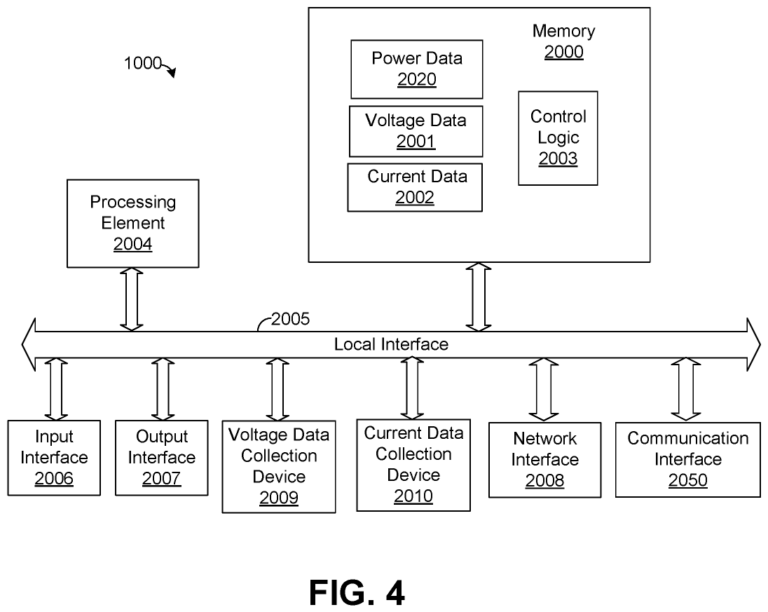

FIG. 4 depicts an exemplary embodiment of the transformer monitoring device 1000 depicted in FIG. 2. As shown by FIG. 3, the transformer monitoring device 1000 comprises control logic 2003, voltage data 2001, current data 2002, and power data 2020 stored in memory 2000.

The control logic 2003 controls the functionality of the operations transformer monitoring device 1000, as will be described in more detail hereafter. It should be noted that the control logic 2003 can be implemented in software, hardware, firmware, or any combination thereof. In an exemplary embodiment illustrated in FIG. 4, the control logic 2003 is implemented in software and stored in memory 2000.

Note that the control logic 2003, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the transformer monitoring device 1000 depicted by FIG. 4 comprises at least one conventional processing element 2004, such as a digital signal processor (DSP) or a central processing unit (CPU), that communicates to and drives the other elements within the transformer monitoring device 1000 via a local interface 2005, which can include at least one bus. Further, the processing element 2004 is configured to execute instructions of software, such as the control logic 2003.

An input interface 2006, for example, a keyboard, keypad, or mouse, can be used to input data from a user of the transformer monitoring device 1000, and an output interface 2007, for example, a printer or display screen (e.g., a liquid crystal display (LCD)), can be used to output data to the user. In addition, a network interface 2008, such as a modem or wireless transceiver, enables the transformer monitoring device 1000 to communicate with the network 9004 (FIG. 2).

In one embodiment, the transformer monitoring device 1000 further comprises a communication interface 2050. The communication interface 2050 is any type of interface that when accessed enables power data 2020, voltage data 2001, current data 2002, or any other data collected or calculated by the transformer monitoring device 100 to be communicated to another system or device. As an example, the communication interface may be a serial bus interface that enables a device that communicates serially to retrieve the identified data from the transformer monitoring device 1000. As another example, the communication interface 2050 may be a universal serial bus (USB) that enables a device configured for USB communication to retrieve the identified data from the transformer monitoring device 1000. Other communication interfaces 2050 may use other methods and/or devices for communication including radio frequency (RF) communication, cellular communication, power line communication, and WiFi communications. The transformer monitoring device 1000 further comprises one or more voltage data collection devices 2009 and one or more current data collection devices 2010. In this regard, with respect to the transformer monitoring device 1000 depicted in FIG. 3, the transformer monitoring device 1000 comprises the voltage data collection device 2009 that may include the cables 1004, 1007 (FIG. 3) that sense voltages at nodes (not shown) on a transformer to which the cables are attached. As will be described further herein, the control logic 2003 receives data via the cables 1004, 1007 indicative of the voltages at the nodes and stores the data as voltage data 2001. The control logic 2003 performs operations on and with the voltage data 2001, including periodically transmitting the voltage data 2001 to, for example, the server 9006 (FIG. 2).

Further, with respect to the transformer monitoring device 1000 depicted in FIG. 3, the transformer monitoring device 1000 comprises the current sensors (not shown) contained in the sensing unit housing 1005 (FIG. 3) and the sensing unit housing section 1018 (FIG. 3), which are described hereinabove. The current sensors sense current traveling through conductor cables (or neutral cables) around which the sensing unit housings 1005, 1018 are coupled. As will be described further herein, the control logic 2003 receives data indicative of current from the satellite sensing unit 1021 (FIG. 3) via the cable 1011 and data indicative of the current from the current sensor of the main unit 1001 contained in the sensing unit housing section 1018. The control logic 2003 stores the data indicative of the currents sensed as the current data 2002. The control logic 2003 performs operations on and with the current data 2002, including periodically transmitting the voltage data 2001 to, for example, the operations computing device 9006 (FIG. 2).

Note that the control logic 2003 may perform calculations with the voltage data 2001 and the current data 2002 prior to transmitting the voltage data 2001 and the current data 2002 to the operations computing device 287. In this regard, for example, the control logic 2003 may calculate power usage using the voltage data 2001 and current data 2002 over time and periodically store resulting values as power data 2020.

During operation, the control logic 2003 may transmit data to the operations computing device 287 via the cables via a power line communication (PLC) method. In other embodiments, the control logic 2003 may transmit the data via the network 9006 (FIG. 2), wirelessly or otherwise.

Furthermore, the server 1000 calculates GHG and CER as described hereinabove. In this regard, the intra-grid sensors 1000 transmits data to the server 9006 indicative of power output of its respective transformer to which it is coupled. In response, the server 9006 calculates GHG and CER, as described hereinabove.

FIG. 5 depicts an exemplary polyphase intra-grid sensor 1499 in accordance with an embodiment of the present disclosure. For purposes of this disclosure, in one embodiment, polyphase refers to a system for distributing alternating current electrical power and has three or more electrical conductors wherein each carry alternating currents having time offsets one from the others. Note that while the polyphase intra-grid sensor 1499 is configured to monitor up to four conductors (not shown), the polyphase intra-grid sensor may be used to monitor one or more conductors, e.g., single phase or two-phase power, which is substantially like monitoring three-phase power, which is described further herein.

Notably, the polyphase intra-grid sensor 1499 may serve the purpose and functionality and is a type of intra-grid sensor. Thus, the polyphase intra-grid sensor collects power and electrical characteristic data related to a distribution transformer 121 and 104 (FIG. 1).

The polyphase intra-grid sensor 1499 comprises a control box 1498, which is a housing that conceals a plurality of electronic components that control the polyphase intra-grid sensor 1499. Additionally, the polyphase polyphase intra-grid sensor 1499 comprises a plurality of satellite current sensors 1490-1493.

The satellite current sensors 1490-1493 are structurally and functionally substantially like the satellite unit 1021 described regarding FIGS. 3, 7, and 8. In this regard, the satellite current sensors 1490-1493 detect a current through an electrical cable, bus bar, or any other type of node through which current passes into and/or from a distribution transformer.

Further, the satellite current sensors 1490-1493 are electrically connected to the control box 1498 (and to the electronics (not shown) contained therein). In this regard, the satellite current sensor 1490 may be electrically connected via connectors 1464, 1460 on the satellite current sensor 1490 and the control box 1498, respectively, by a voltage current cable 1480. Similarly, the satellite current sensor 1491 is electrically connected via connectors 1465, 1461 on the satellite current sensor 1491 and the control box 1498, respectively, by a voltage current cable 1481, the satellite current sensor 1492 is electrically connected via connectors 1466, 1462 on the satellite current sensor 1492 and the control box 1498, respectively, by a voltage current cable 1482, and the satellite current sensor 1493 is electrically connected via connectors 1467, 1463 on the satellite current sensor 1493 and the control box 1498, respectively, by a voltage current cable 1483.

Note that the current cables 1480-1483 may be an American National Standards Institute (ANSI)-type cable. In one embodiment, the current cables 1480-1483 are insulated, and may be any other type of cable known in the art or future-developed configured to transfer data indicative of current measurements made by the satellite current sensors 1490-1493 to the control box 1498.

In addition, each current cable 1480-1483 is further associated with a voltage cable 1484-1487. In this regard, each voltage cable 1484-1487 extends from the connectors 1460-1463 on the control box 1498 and terminates with ring terminals 1476-1479, respectively.

Note that in one embodiment of the polyphase polyphase intra-grid sensor 1499, connectors 1460-1463 may be unnecessary. In this regard, the conductors 1480-1483 and conductors 1484-1487 may be connected to electronics directly without use of the connectors 1460-1463.

During operation, one or more of the satellite current sensors 1490-1493 are installed about conductors (e.g., cables), bus bars, or other type of node through which current travels. In addition, each of the ring terminals 1476-1479, respectively, are coupled to the conductor, bus bar, or other type of node around which their respective satellite current sensor 1490-1493 is installed.

More specifically, each satellite current sensor 1490-1493 takes current measurements over time of current that is flowing through the conductor cable, bus bar, or node around which it is installed. Also, over time, voltage measurements are sensed via each of the satellite current sensor's respective voltage cables 1484-1487. As will be described herein, the current measurements and voltage measurements taken over time are correlated and thus used to determine power usage corresponding to the conductor cable, bus bar, or node.

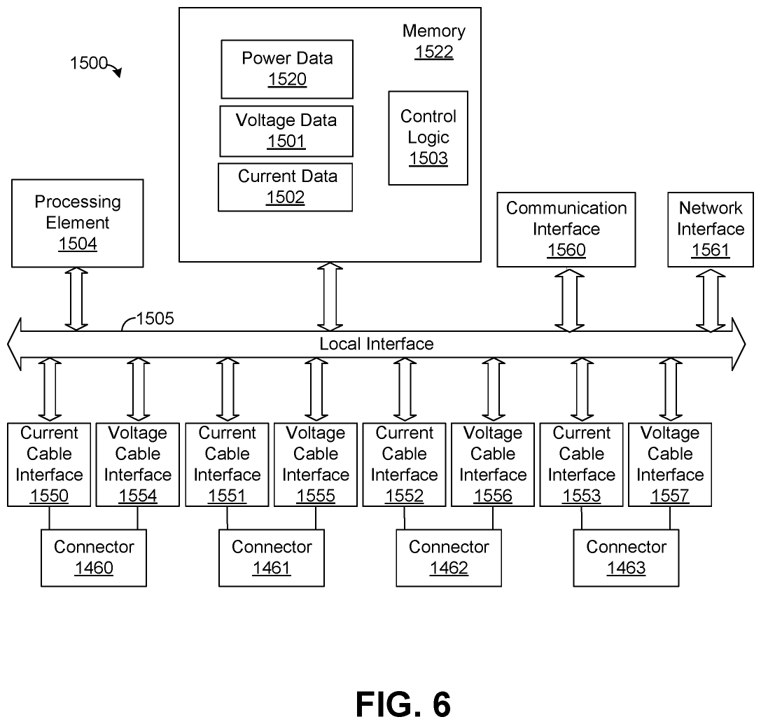

FIG. 6 depicts an exemplary embodiment of a controller 1500 that is housed within the control box 1498. As shown by FIG. 15A, the controller 1500 comprises control logic 1503, voltage data 1501, current data 1502, and power data 1520 stored in memory 1522.

The control logic 1503 controls the functionality of the controller 1500, as will be described in more detail hereafter. It should be noted that the control logic 1503 can be implemented in software, hardware, firmware, or any combination thereof. In an exemplary embodiment illustrated in FIG. 15, the control logic 1503 is implemented in software and stored in memory 1522.

Note that the control logic 1503, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the controller 1500 depicted by FIG. 15 comprises at least one conventional processing element 1504, such as a digital signal processor (DSP) or a central processing unit (CPU), that communicates to and drives the other elements within the controller 1500 via a local interface 1505, which can include at least one bus. Further, the processing element 1504 is configured to execute instructions of software, such as the control logic 1503.

In addition, a network interface 1561, such as a modem or wireless transceiver, enables the controller 1500 to communicate with the network 280 (FIG. 2A).

In one embodiment, the controller 1500 further comprises a communication interface 1560. The communication interface 1560 is any type of interface that when accessed enables power data 1520, voltage data 1501, current data 1502, or any other data collected or calculated by the controller 1500 to be communicated to another system or device.

As an example, the communication interface 1560 may be a serial bus interface that enables a device that communicates serially to retrieve the identified data from the controller 1500. As another example, the communication interface 1560 may be a universal serial bus (USB) that enables a device configured for USB communication to retrieve the identified data from the controller 1500. Other communication interfaces may use other methods and/or devices for communication including radio frequency (RF) communication, cellular communication, power line communication, and Wi-Fi communications.

The controller 1500 further comprises one or more current cable interfaces 1550-1553 and voltage cable interfaces 1554-1557 that receive data transmitted via the current cables 1480-1483 and voltage cables 1484-1487, respectively. In this regard, each current cable interface/voltage cable interface pair is associated with a single connector. For example, connector 1460 receives cables 1480 (current) and 1484 (voltage), and the current cable interface 1550 receives data indicative of current and the voltage cable interface 1554 receives data indicative of current associated with the conductor about which the satellite current sensor 1490 is installed.

Similarly, connector 1461 receives cables 1481 (current) and 1485 (voltage), and the current cable interface 1551 receives data indicative of current and the voltage cable interface 1555 receives data indicative of current associated with the conductor about which the satellite current sensor 1491 is installed. The connector 1462 receives cables 1482 (current) and 1486 (voltage), and the current cable interface 1552 receives data indicative of current and the voltage cable interface 1556 receives data indicative of current associated with the conductor about which the satellite current sensor 1492 is installed. Finally, connector 1463 receives cables 1483 (current) and 1487 (voltage), and the current cable interface 1553 receives data indicative of current and the voltage cable interface 1557 receives data indicative of current associated with the conductor about which the satellite current sensor 1493 is installed.

During operation, the control logic 1503 receives the voltage and current data from the interfaces 1550-1557 and stores the current data as current data 1502 and the voltage data as voltage data 1501. The control logic 1503 performs operations on and with the voltage data 1501 and current data 1502, including periodically transmitting the voltage data 1501 and current data 1502 to, for example, the operations computing device 287 (FIG. 2A).

Note that the control logic 1503 may perform calculations with the voltage data 1501 and the current data 1502 prior to transmitting the voltage data 1501 and the current data 1502 to the operations computing device 287. In this regard, for example, the control logic 2003 may calculate power usage using the voltage data 1501 and current data 1502 over time and periodically store resulting values as power data 1520.

During operations, the control logic 1503 may transmit data to the operations computing device 287 via the cables using a power line communication (PLC) method. In other embodiments, the control logic 1503 may transmit the data via the network 280 (FIG. 2A) wirelessly or otherwise.

Note that going forward, the monitoring device 1000 and the monitoring device 1499 may be used interchangeably in the present disclosure. Thus, for ease of description, monitoring device 1000 and monitoring device 1499 are generally referred to as polyphase intra-grid sensor plurally or intra-grid sensor singularly.

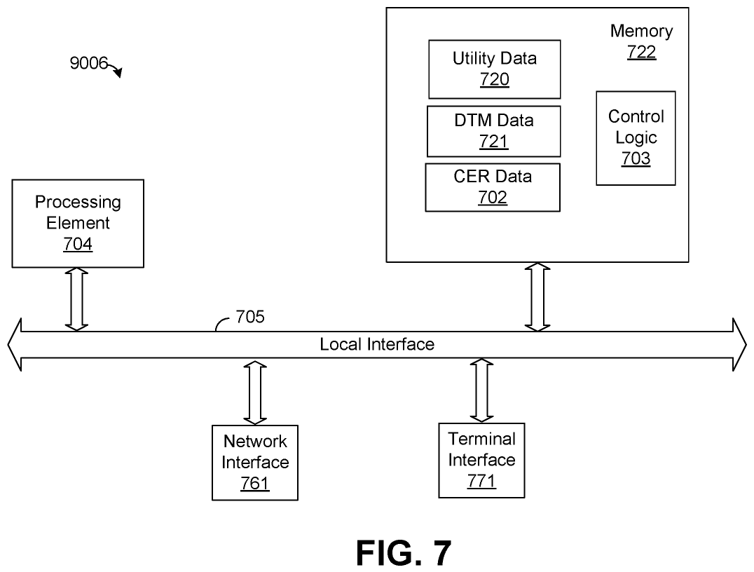

FIG. 7 depicts an exemplary embodiment of the server 9006 depicted in FIG. 2. As shown by FIG. 4, the server 9006 comprises control logic 703, utility data 720, intra-grid sensor data 721, and CER data 312 all stored in memory 722.

The control logic 703 generally controls the functionality of the server 9006, as will be described in more detail hereafter. It should be noted that the control logic 703 can be implemented in software, hardware, firmware, or any combination thereof. In an exemplary embodiment illustrated in FIG. 7, the control logic 703 is implemented in software and stored in memory 722.

Note that the control logic 703, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the server 9006 depicted by FIG. 7 comprises at least one conventional processing element 704, such as a digital signal processor (DSP) or a central processing unit (CPU), that communicates to and drives the other elements within the server 9006 via a local interface 705, which can include at least one bus. Further, the processing element 704 is configured to execute instructions of software, such as the control logic 703.

As indicated hereinabove, the utility data 720, the intra-grid sensor data 721, and the CER data 702 are stored in memory 722. The utility data 720 is data received from a utility company. For example, the utility data may identify transformers and their respective power ratings, meters, their locations, and operation data obtained during operation.

In one embodiment, the control logic 703 receives the utility data 720 and stores utility data 720 such that the utility data 720 may be retrieved to perform calculations related to GHG and CER for a particular segment of the grid or for the grid. Note that utility data 720 is dynamic and is collected periodically automatically or upon demand. For example, the utility data 720 may include, but is not limited to, data indicative of current measurements, voltage measurements, and/or power calculations over a period per transformers and/or meters.

The intra-grid sensor data 721 is data indicative of data received from intra-grid sensor(s). Such data is dynamic and is collected periodically or upon demand. Note that the intra-grid sensor data 721 comprises data indicative of current measurements, voltage measurements, and/or power calculations over a period that indicates the amount of aggregate power provided to the consumer premises 106-111. Notably, the intra-grid sensor data 721 comprises data indicative of the aggregate power that is being sent to a “group,” i.e., two or more consumer premises being monitored by the intra-grid sensor(s) although the intra-grid sensor data 721 can comprise power data that is being sent to only one consumer premises being monitored by the intra-grid sensor.

During operation, the analytic logic 308 receives meter data 935-940 via the network interface 305 from the network 280 (FIG. 2) and stores the meter data 935-940 as meter data 390 in memory 300. The meter data 390 is stored such that it may be retrieved corresponding to the distribution transformer 104, 121 supplying the consumer premise 106-111 to which the meter data corresponds. Note there are various methods that may be employed for storing such data including using unique identifiers, as described hereinabove, or configuration data 312, also described hereinabove.

The CER data 702 is any data that the control logic 9006 may use to calculate GHG and corresponding CER. This data is indicated hereinabove. Notably, the CER data will comprise at least a constant per country that may be used in the calculation of the CER. As an example, used above, the constant for the United States is 0.535 for fuel mix and 1.003 for straight fossil fuel calculations.

The control logic 703 may perform a variety of functions to further analyze the utility data 720, the intra-grid sensor data 721, and the CER data 702 to ascertain CERs. Additionally, the control logic 703 may display a graphical user interface to the terminal 9005, including any collected or calculated data. Further, if there is a discrepancy in the grid or in a grid segment, the control logic 703 may transmit data to the terminal 9005 notifying the operator (not shown) of the discrepancy. For example, if more power is being outputted by a transformer than is being delivered to meters attached thereto, the control logic 703 may transmit data to the terminal 9005 alerting the operator of the discrepancy so that the operator may take remedial action. Likewise, if an oversized transformer is being used to deliver power to endpoints, the control logic 703 may transmit a notification to the terminal 9005 to alert the operator of the oversized transformer. These are merely exemplary, the control logic 703 may transmit a notification to the terminal 9005 at any time there is a discrepancy or anomaly in the grid or grid segment.

In one embodiment, the intra-grid sensors may monitor photovoltaic energy (or any type of energy that could likely push energy onto the grid). The control logic 703 identifies the kilowatt hours (kWh) of reverse energy being driven onto the distribution grid. Data indicative of the amount of reverse energy is provided to the terminal 9005, and the operator or the utilities can reduce the amount of power being driven onto the transmission and distribution grids. In such an embodiment, the server 9006 is configured to quantify the GHG reductions directly via the kWh information captured by the intra-grid sensors in addition to other relevant data that will strengthen or increase the quantity of GHG reduction.

In one embodiment, the intra-grid sensors are configured to identify intra-grid loss, e.g., power theft or oversized transformers. The control logic 703 may receive data indicative of the intra-grid loss and provide this data to the operator or to the utilities, and the operator or the utilities may use the quantified loss to purchase less power, which leads to lower generation of power. Less power generation results in lowered or reduced GHG. This reduction in GHG may then be used to obtain CER credits.

In one embodiment, the intra-grid sensors are configured to identify intra-grid waste and inefficiency (“inefficiency loss”). The control logic 703 may provide data indicative of the inefficiency loss may be provided to utilities. The utilities can purchase less power based upon the quantified inefficiency loss, which leads to lowered power generation and less GHG emissions. The lowered GHG emissions may then in turn be used to obtain CER credits.

Note that there exists a global commodities market for CER credits. The GHG emission reductions described hereinabove that are captured by the intra-grid sensors may then be provided to the global commodities market for CER credits.

In one embodiment of the present disclosure and for the purpose of loss identification within the distribution grid, the system 2000 (FIG. 2) of the present disclosure may use the following data points provided by utility companies (which is in addition to comparative data points secured by the intra-grid sensors, which enable the system to isolate loss):

Inputs for all circuit feeders when determining CER credits:
1. Feeder energy consumption (kWh) for X period;
2. Aggregated end meter energy consumption for X period;
3. Authorized unmetered energy consumption for X period;
4. Meter to transformer association (GIS info);
5. Transformer to feeder association;
6. feeder length;
7. Transformer to feeder association;
8. Transformer quantity by type (pole, pad, vault, etc.)

Optional Data that may be required to derive CER credits:
1. Meter's geographic location;
2. Transformers geographic location;
3. Feeder line diagram;
4. Feeder primary voltage and configuration (i.e., delta, wye);
5. Feeder conductor type;
6. Transformer rating (KVA);
7. Transformer impedance and losses (iron losses and copper losses);
8. Transformer manufacturer, model, and serial number;
9. Transformer aging profile (i.e., installation dates of transformers).

Additionally, the control logic 703 in accordance with an embodiment of the present disclosure determines energy purchase cost reduction opportunities for utilities (which is in addition to comparative data points secured by the intra-grid sensors that enable the system 2000 (FIG. 2) to isolate excessive voltages). Data used for this purpose is described as follows:
1) substation-level data energy expressed as Mega Watts and Voltages and obtained at 15 minute or hourly intervals aggregated to a single substation-level transformer, which delivers energy to the associated circuit feeder.
2) transformer-level data expressed as Mega Watts and Voltages and obtained at 15-minute intervals or hourly from the associated circuit feeder(s) and/or grid(s). Noting that alternative data intervals may be required by certain jurisdictions for which intra-grid sensors will provide such interval data.

In another embodiment, the intra-grid sensor may be used to verify and/or to accurately map transformer-to-downstream meter associations. As an example, distribution transformer 104 (FIG. 1) is shown being coupled to meters 112-114. However, over time the association of meters 112-114 may change, (e.g., an additional meter may be added, or an existing meter may be removed over time, thereby eroding AMI meter reading accuracy regarding upstream transformer and/or related distribution assets conditions).

Oftentimes, geographic information systems (GIS) solutions are used to map meters to a corresponding transformer(s), even though this asset relationship may perpetually change. This asset relationship of meters to transformer(s) may change due to storms, pole damage, flawed clerical recording/ongoing record keeping, etc. thereby rendering the asset mapping resource, and the related intra-grid conditions understandings to become erroneous.

In the present embodiment, the intra-grid sensors obtain voltage levels at the transformer. The intra-grid sensors compare this voltage to the voltage used by the downstream meters. If the voltages are vastly different, this may mean that a utility's GIS mapping of transformer-to-meters is no longer accurate. If the voltages are vastly different this may indicate an energy loss. This condition may then be remedied by the grid operator by using intra-grid sensors to determine the root cause of the disparity in voltages data.

Energy Efficiency improvements and conservation efforts are important aspects of creating a sustainable planet, and addressing the changing electricity demands of our world. Using newly emerging intra-grid sensors, electric grid operators are now capable of successfully addressing a series of unplanned and oftentimes unknown grid-edge developments and fulfilling the increasing grid reliability expectations being presented by stakeholders. With the evolution of Distributed Energy Resources (DER) from solar and wind, along with increasing uptake in electric vehicles (EV), and the evolution of legalized marijuana, electric distribution grids are experiencing many previously unforeseen challenges. Additionally, distribution grids have perennially been the target of substantial levels of power theft which experts [symbol] being in the range of $6 Billion to $9 Billion per year in the US alone.

There is ongoing interest throughout the world to achieve Decarbonization via the reduction of Greenhouse Gas (GHG) emissions, as validated by the Paris Agreement presented by the United Nations Framework Convention on Climate Change (UNFCCC), and adopted by consensus on 12 Dec. 2015. Within this framework, 196 international countries, and certain US states have declared their commitment to reduce GHG. The Paris Agreement aims to lessen fossil fuel-based impacts on our global and local environments. To this end, approximately 65% of the US electricity generation is derived from fossil fuel sources, with many countries around the world sharing similar (or worse) electricity generation source profiles. The reduction of fossil-fuel based electricity generation is now a desirable interest since this will result in decreased GHG emissions for which experts believe will yield beneficial impacts upon global climate change.

Virtually every electricity distribution grid in the world experiences substantial energy loss between substations and endpoint meters. In the US alone, approximately $20 Billion per year of energy departs substations but never arrives at the intended downstream endpoint meters. This represents approximately 200 Billion kilowatt hours per year of energy Loss within the US distribution grid alone. This type of perennial ‘Loss” represents significant energy inefficiency that has pervasively existed throughout most distribution grids since the inception of electricity delivery to end users. However, due to emerging intra-grid sensors, a meaningful portion of this annual “Loss”, or energy inefficiency, can now be cost-effectively identified and remediated by grid operators using intra-grid sensors. Thus, carbon emissions reducing energy efficiency improvements are now made available by intra-grid sensors which then results in distribution grid efficiency gains, associated upstream energy efficiency, thereby enabling reduced electricity generation, including less fossil-fuel based generation. This type of energy efficiency gain also ensures that highly prized clean energy is used efficiently, versus otherwise being wasted to varying degrees given historic/perennial distribution grid inefficiencies that have plagued operators and ratepayers since the inception of electricity delivery.

To this end, intra-grid sensors 9001-9000ₙ can be utilized to locate unmetered technical and non-technical loss, and permit utility operators to remediate this energy inefficiency within their distribution grids. The control logic 703 may identify loss within the distribution grid that will be equated into kilowatt hours to be saved, then also be forecasted to the commensurate kilowatt hour savings to be realized within the transmission grids as the result of improved energy efficiency in the distribution grids. Collectively, the distribution and transmission efficiency improvements will be forecast in some form of kilowatt hours of energy efficiency improvements to ultimately extrapolate the reduced electricity generation value; thereby concluding Greenhouse Gas (GHG) reduction capability, and Carbon Emissions Reduction (CER) credits value. By reducing energy inefficiency, and therefore achieving improved energy efficiency via intra-grid sensors, distribution grid efficiencies and upstream improvements will result in decreased, unnecessary electricity generation, thereby assisting in the global effort to lessen GHG emissions.

Simultaneously, given the ability of intra-grid sensors 9001-9000ₙ to accurately record both forward and reverse energy, the amount of reverse energy driven into the distribution grid from DER (e.g., solar, wind) will be measured at the distribution transformer(s). The aggregated reverse energy produced by renewables such as solar and wind will help to offset traditional electricity generation, and therefore also equate to reduced electricity generation demand. Thus, recorded reverse energy (kilowatt hours) will similarly be used to forecast reduced electricity generation which will result in further GHG reduction.

Notably, one aspect of the present disclosure is the reduction of GHG so that kWh being generated may be reduced. Reduction of GHG reduces CO₂ emissions: The following formula represents how the system 2000 (FIG. 1) can be used to accomplish this task:

(Remediable Technical Loss+Non-Technical Loss)+Distributed Energy Resources

By addition of the remediable losses and the addition of the DER, one can effectively quantify reductions that can lead to a reduction in GHG and a decrease in CO₂ emissions.

What we claim is

1. A system for reducing greenhouse gas emissions, the system comprising:
an intra-grid sensor, the intra-grid sensor coupled to a secondary side of a transformer, the transformer configured for delivering power to a customer premise through a meter, the intra-grid sensor configured for measuring an amount of power at the transformer to be delivered to the customer premise through the meter and for transmitting data indicative of the measured power at the transformer to a server;
a processor resident on the server, the processor configured for ascertaining non-technical loss based upon the data indicative of the measured power.

2. The system of claim 1, wherein the processor is further configured for comparing the data indicative of the amount of measured power to data indicative of a meter power measured at the meter of the customer premises.

3. The system of claim 2, wherein the processor if further configured for notifying an operator and/or a utility company of non-technical loss if the measured power is substantially more than the meter power.

4. The system of claim 1, wherein the processor is further configured to notify an operator and/or a utility company if the measured power substantially exceeds an amount of power measured the meter

5. The system of claim 1, wherein the processor is further configured for determining power provided by a distributed energy resource (DER) and calculating an energy loss based upon the power provided by the DER.

6. The system of claim 1, wherein the processor is further configured for determining power utilized by an electric vehicle (EV) charging station and calculating an energy loss based upon the power provided to the EV charging station.

7. The system of claim 1, wherein the processor is further configured for calculating greenhouse gas (GHG) emissions based upon non-technical loss, technical loss, and distributed energy resources.

8. The system of claim 7, wherein the processor is further configured to calculate carbon emission reduction credits based upon the GHG emissions.

9. The system of claim 1, wherein the processor is further configured for transmitting data to a computer terminal indicating a discrepancy so that an operator of the terminal or a utility company can remediate the discrepancy.

10. The system of claim 1, wherein the processor is further configured for comparing the amount of measured power to a metered power.

11. The system of claim 10, wherein if the metered power substantially exceeds the measured power, the processor is further configured for notifying an operator of a terminal or a utility company so that the operator or the utility company can take remedial action.

12. The system of claim 1, wherein if a metered power is substantially less than the measured power, the processor is further configured for notifying an operator or a utility company so that they make take remedial action.

13. The system of claim 1, wherein if a measured power is substantially greater than a metered power, the processor is further configured for notifying an operator or a utility company so that they make take remedial action.

14. The system of claim 1, wherein the processor is further configured to compare a power rating on the transformer to a plurality of aggregate power measurements of a plurality of meters.

15. The system of claim 14, wherein if the power rating is substantially greater than the aggregate power measurements, the processor is further configured to notify an operator and/or a utility via a terminal so that they can take remedial action.

16. A method for reducing greenhouse gas emissions, the method comprising:
coupling an intra-grid sensor to a secondary side of a transformer;
delivering power, by the transformer, to a customer premise through a meter;
measuring, by the intra-grid sensor an amount of power at the transformer to be delivered to the customer premises through the meter;
transmitting data indicative of the measured power at the transformer to a server; and
ascertaining, by a processor on the server, non-technical loss based upon the data indicative of the measured power.

17. The method of claim 16, further comprising comparing, by the processor, the data indicative of the amount of measured power to data indicative of a meter power measured at the meter of the customer premises.

18. The method of claim 17, further comprising notifying, by the processor, an operator and/or a utility company of non-technical loss if the measured power is substantially more than the meter power.

19. The method of claim 16, further comprising notifying, by the processor, an operator and/or a utility company if the measured power substantially exceeds an amount of power measured the meter

20. The method of claim 16, further comprising determining, by the processor, power provided by a distributed energy resource (DER) and calculating an energy loss based upon the power provided by the DER.

21. The method of claim 16, further comprising determining, by a processor, power utilized by an electric vehicle (EV) charging station and calculating an energy loss based upon the power provided to the EV charging station.

22. The method of claim 16, further comprising calculating, by the processor, greenhouse gas (GHG) emissions based upon non-technical loss, technical loss, and distributed energy resources.

23. The method of claim 22, further comprising calculating, by the processor, carbon emission reduction credits based upon the GHG emissions.

24. The method of claim 16, further comprising transmitting, by the processor, data to a computer terminal indicating a discrepancy so that an operator of the terminal or a utility company can remediate the discrepancy.

25. The method of claim 1, further comprising comparing, by the processor, the amount of measured power to a metered power.

26. The method of claim 25, wherein if the metered power substantially exceeds the measured power, notifying, by the processor, an operator of a terminal or a utility company so that the operator or the utility company can take remedial action.

27. The method of claim 1, wherein if a metered power is substantially less than the measured power, notifying, by a processor, an operator or a utility company so that they make take remedial action.

28. The method of claim 1, wherein if a measured power is substantially greater than a metered power, notifying, by a processor, an operator or a utility company so that they make take remedial action.

29. The method of claim 1, further comprising comparing, by a processor, a power rating on the transformer to a plurality of aggregate power measurements of a plurality of meters.

30. The method of claim 29, wherein if the power rating is substantially greater than the aggregate power measurements, notifying, by the processor, an operator and/or a utility via a terminal so that they can take remedial action.
